(19) United States
(12) Patent Application Publication
(10) Pub. No.: US 2020/0068293 A1
(43) Pub. Date: Feb. 27, 2020

(54) Bass Loud Speaker for Corner Placement

(71) Applicant: Hans-Christoph Kastl, Rio de Janeiro (BR)

(72) Inventor: Hans-Christoph Kastl, Rio de Janeiro (BR)

(21) Appl. No.: 16/113,871

(22) Filed: Aug. 27, 2018

(51) Int. Cl. H04R 1/30; H04R 7/16; H04R 1/28

(52) U.S. Cl. CPC H04R 1/30; H04R 1/2819; H04R 7/16

(57) ABSTRACT

Presented is an acoustic low frequency horn for corner placement, radiating backward into the corner cube, from where the waves are reflected to the room, guided by 3 plains out of the corner ideally forming the biggest possible conical horn. Providing a smooth expansion of the wave path avoids the formation of a horn mouth and the problems therefrom. In consequence it has a high efficiency and needs only a smaller speaker that fits into an enclosure of about one magnitude smaller size than comparable corner horns. Thereby retaining the excellent reproduction characteristics of an over sized bass horn, but with reduced enclosure size, material and overall cost. It comes without cutoff frequency effect and can play down to the limit of human audibility without changing its characteristics at lowest frequencies.

### TECHNICAL FIELD OF THE INVENTION

The field of this invention is in acoustical reproduction of lower audible frequencies in a room e.g. for Home Theater (HT).

### CROSS-REFERENCE TO RELATED APPLICATIONS

U.S. PATENT DOCUMENTS

| | | |
|---|---|---|
| 1,477,554 | December 1923 | Grissinger |
| 1,984,550 | May 1929 | Sandeman |
| 2,203,875 | December 1937 | Olson |
| 2,338,262 | January 1944 | Salmon |
| 2,915,588 | December 1959 | Bose |
| 4,071,112 | September 1975 | Keele |
| 4,213,008 | July 1980 | Helffrich |

FOREIGN PATENT DOCUMENTS

| | | |
|---|---|---|
| DE 19537582 | October 1995 | Nickel |

### LITERATURE

D. Keele Jr. Maximum Efficiency of Direct-Radiator Loudspeakers AES Preprint No. 3193(G-3), October 1991

### BACKGROUND ART

Less than one Watt of acoustical energy can already fill an auditorium with sound, but it is difficult to reproduce all that by one speaker with high fidelity, what was recorded by many musicians and instruments. It is therefor common practice to divide the audible frequency range into two or more sections.

As bigger instruments produce deeper bass, so do speakers. For a higher level of sound (SPL) we can increase the power or the efficiency, but to radiate deep bass with good efficiency, even when seizing ⅛-space, big vibrating areas are mandatory. In direct radiating mode for a diaphragm area and in indirect radiating mode by a horn for a mouth area. Both require very much space, so they are usually not practicable for HT.

Direct radiating speakers radiate down to their resonant frequency, which can be made low enough, but their problem is efficiency, which drops at 16 Hz e.g. for a 12″-speaker down to 0.01% at it's best and it gets worse with smaller boxes and speakers. So 1,000 W of amplifier power generate 0.1 W of deepest bass waves.

Exponential horns have a cutoff frequency effect which depends on an empirically found rate of flare (in short: ‘flare’ or ‘flare frequency’), which is defined as the relative change in wave-front area per distance, and their mouth area size which should be the same as of a direct radiating diaphragm, so they cannot be made smaller without performance loss, too. Solving this dilemma is matter of the present invention.

The “sound enhancing” effect of funnels and horns is known for thousands of years. Based on work of d'Alembert (1752), the solution of 1919 from Webster for the simplified one-dimensional wave equation is used until today for calculations. The most significant inventions for horns have been made in the first part of the 20th century when only few power was available. Harry F. Olson developed at RCA calculation basics for moving coil speakers and V. Salmon unified the mathematical law of conical, exponential and hyperbolic horn shapes, later named ‘Salmon Horn Family’. So horns can be optimized for frequency range, sensitivity, efficiency, inlet area size, horn length, distortion, maximum power, dispersion or directivity.

E. K. Sandeman and Amar Bose showed how to use corner-planes to increase the radiating resistance and efficiency for a loud speaker at low frequencies. Nevertheless a conical corner horn is frequently considered useless for deep bass. It's problem is a very high flare at the vertex, lowering only with distance, which is diametrically opposed to what is needed for bass horns and thus prevents efficient bass radiation until a distance from the vertex, where the radiating area 10 (FIG. 1) is greater than ⅛th of the needed sphere in free space. Not by chance, this equals the radiating area 10 (FIG. 2) of a conventional horn mouth and a direct radiating diaphragm.

There are lots of patented horn designs that are built within a corner. Seizing the advantage of a ⅛th space and the wall planes to economize volume size and material for a bass horn is such an alluring and apparently good trick, that folded corner horns are happily built within corners. But their problem is: for a proper horn never is enough space within the corner. Group delay becomes an audible problem at higher bass for sensible listeners and compromise is required between time delay, horn length, mouth size and mouth reflections that restrict the usable frequency range and the horn is still of cumbersome size. So you always end up with a lot of well known disadvantages: cutoff frequency, mouth reflections, impedance peaks, excessive diaphragm excursions, transmission line behavior, ‘bumpy’ frequency response, to name some.

After more than hundred patents about horns, is there anything left for investigation? Despite of growing demand, reproduction of bass waves is anything but perfect. Only at a first glance we are seemingly in control and know what it needs, that already all is known and invented. But we are far from that, otherwise we would not spend up to several thousands of amplifier watts in HT to generate sub bass waves of little acoustic power. Our mathematical models are very simplified and small ideally infinite horns without mouth reflections are only fictive and used in mathematics. In 1980 Edmund R. Helffrich noted in U.S. Pat. No. 4,213,008 [Col., L 29-34]:

“The ideal speaker enclosure for driving an one-eighth spherical air column would be an enclosure whose horn feeds smoothly thereinto without discontinuities attributable to a sudden change in the expansion rate at the mouth of the horn.” He talks of a mouth without discontinuity, which would be an infinite horn and then of course have no mouth.

In 1995 Putland cited in his PhD thesis Chapter 1, Introduction [p. 23] a speaking of Prof. V. Karapetoff:

“This problem of horns is a “house-on-fire” problem, in the sense that loudspeakers now are being manufactured by the thousands, and while they are being manufactured and sold, we are trying to find out their fundamental theory” which was at a convention of the American Institute of Electrical Engineers in 1924. More than ninety years later there is a lot of progress but not much change, only cheap D-class amplifier power is available now and instead of overhung coil motors some have underhung technology, to better handle that power.

It is the aim of this invention to provide a corner bass horn speaker with dimensions of a common speaker tower, that is applicable to living-room use.

### BRIEF SUMMARY OF THE INVENTION

### Technical Problem

In modern home entertainment good reproduction of lowest audible frequencies is more desirable than ever. But physics make it difficult to radiate them from the small speakers preferred by consumers. Closed box speakers are very inefficient and their placing is a challenge. Bass-reflex and transmission-line speakers work with resonances and within a limited frequency range only. Exponential bass horns are big and suffer a sudden change in the expansion at their mouth. They have perceivable time delay, reflections at wave lengths greater than the mouth circumference, and can't be made small. Same with conical corner horns who still require huge vibrating throat-areas that are too big for most homes. An exponential horn can't be just connected to ⅛th-space because of a mismatch in the expansion rate at the required cross sectional area.

### Solution to the Problem

Arranging the inner portion of a corner as an acoustical retro-reflective corner-cube makes it employable for a 180°-folding of a horn that unfolds until that distance from the vertex, where the corner-cone-flare has fallen to a useful rate for bass. With a multi-flare horn of a flare-rate equal to that of the corner-cone at the connection, continued guidance of waves becomes possible without occurring a mouth, a reflective barrier for the propagation, not even for the deepest frequencies. The radiation impedance of the cone-throat from a long conical horn becomes transformed by the horn to the speaker diaphragm even at lowest audible frequencies without presenting a high impedance peak.

### Advantageous Effects of the Invention

With the disclosed method for proper placing, radiating area, throat area and multiple flares, an infinite horn was created that uses the corner, which is frequently wasted space, needs only a simple structure within a small enclosure and is therefor applicable to living-room use. Despite of the small housing there is no sacrifice in quality and it is even light weight and easy to move. With suitable modifications for one or more larger size driving units it can deliver the large amounts of power required for use in theaters, churches or outdoor clusters. It is free of resonances, with good efficiency within the audible bass range, shows small diaphragm excursions, low inter-modulation, low distortion, short time delay, fast response and low production cost.

### BRIEF DESCRIPTION OF THE SEVERAL VIEWS OF THE DRAWING

FIG. 1 Depicts the vibrating area 10 in ⅛th space for efficient radiation of ⅛th spherical wave fronts.

FIG. 2 Is a perspective view of a hyperbolic horn 7 with triangular cross sections and wave fronts changing from plane to ⅛th spherical shape.

FIG. 3 Side view of the hyperbolic horn 7 from FIG. 2 connected with its mouth area 10 to the throat area of the corner cone.

FIG. 4 Side view that shows the hyperbolic horn 7 folded at plane 11 with the reflected wave fronts.

FIG. 5 Same view as FIG. 4, but the hyperbolic horn 7 is additionally folded at plane 13.

FIG. 6 Top view with a displacement 22 from the center-line 17 that causes a conjugated displacement 23.

FIG. 7 Exponential and exponential-hyperbolic horn expansion compared.

FIG. 8 Geometric solution with exponential-hyperbolic graph 1 that tangents the corner cone graph 16 at point 10, resulting in a smooth transition from horn to room.

FIG. 9 Schematic side view in longitudinal section of the example embodiment.

### DETAILED DESCRIPTION OF THE INVENTION

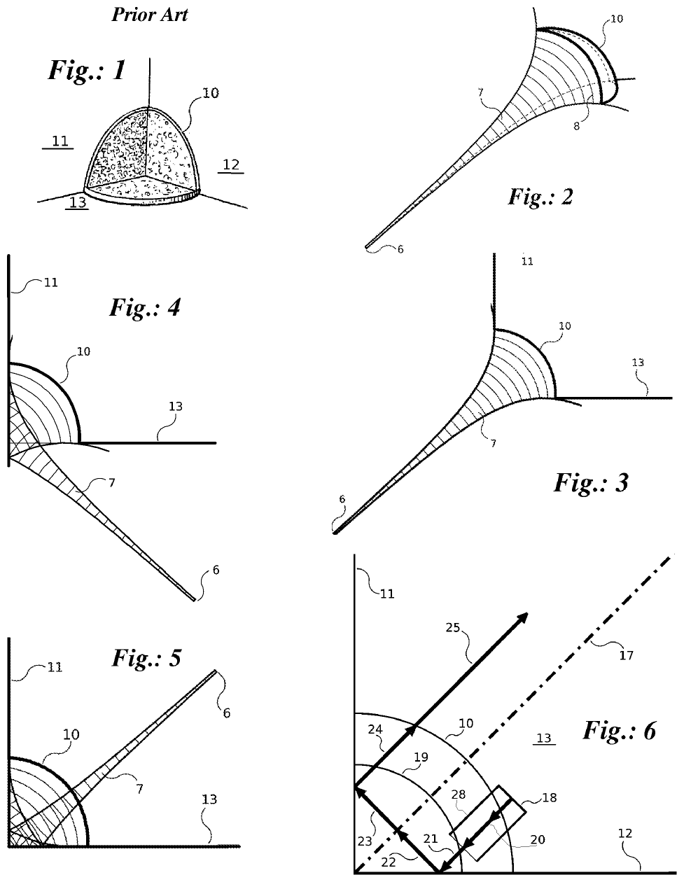

Because a room corner is a ⅛th section of a sphere it forms an ideal conical horn and can be very useful for bass, if used with an adequate throat area at a certain distance from the vertex, shown in U.S. Pat. No. 2,915,588 of Amar Bose. Only at sub-bass arises a size problem, because the required vibrating area 10 in FIG. 1 becomes of huge, room dominating size e.g. with 22 speakers and the huge closed box volume behind them, requiring fixed mounting and sealing to the walls.

The corner space thereby is divided in two by said throat, an inner part starting at the vertex with a fast rate of expansion that is inadequate for bass and an outer part that resembles an infinite conical horn with a load impedance Z_{A} given by:

Z_{A}=ρₒc/S_{T}*((kxₒ+j)/(kxₒ+1/kxₒ)) Math. (1)

where
Z_{A}=Acoustical throat impedance,
S_{T}=Throat area,
k=2π/λ,

### λ=Wavelength,

c=Speed of sound in free air,
ρₒ=Density of air=1.2 kg/m³,
xₒ=Distance of throat from vertex,
j=sqrt(−1)

By its gliding flare the corner cone shows no cutoff frequency. Because of steadily decreasing flare it has no low frequency limit. With a length until the room's end it has no mouth. There is no resonance, no high reactive peak, the lower effectiveness per area at low frequencies can be compensated by a bigger area and always remains a resistive component even below the nominal low frequency limit.

FIG. 2 shows a triangular shaped horn in 3D, with plane wave fronts at the inlet 6, that change gradually to ⅛th spherical shape, mainly in the final portion 8. A horn mouth 10 like that makes a perfect match for said corner cone throat. Also it can make excellent use of the low valued inner corner part, like shown in FIG. 3. As said before it can also be veryfied that a proper horn cannot fit completely into the inner corner and needs some extra space.

If the horn becomes extended basically this way, the required smooth transition to the room without sudden change in the expansion is realized and reflections from the mouth, which always are the principal problem of horns, do not arise at all. Then, the interface 10 becomes the place where the calculation model and flare formula change. Because the flare at the cone-throat implies a certain throat area, we can say that the flare remains the sole criterion for the low frequency limit of propagating waves (called ‘flare limit’).

Corner and wall channel space is often used to place dispersing or damping matter to reduce reflections and reverberation for a better room acoustic. But corner space also resembles a corner cube with the capability to solve the problem of the missing space for the horn. Employing it as an acoustic 3-D retro-reflector can fold the horn for 180°, even with a displacement regardless of the angle of incidence, and can be much more beneficial than only economizing some wooden material, as will be shown following.

First, as depicted in FIG. 4, when reflecting the waves at the left wall 11 as if they could enter the room through the ground plane 13 to achieve the same outcome as before, the horn appears to be mirrored at that wall plane 11. The mirrored waves pass portions within the corner cube two times in different directions, which in effect works as if the missing space virtually were present. An overlay by superposition principle does not affect the propagation of waves within a linear system, only locally appears interference as sum of the amplitudes. The other wall 12, not shown, looks same but horizontally flipped.

Finally FIG. 5 shows the waves entering the corner space, hitting the ground plane 13, being mirrored a first time and then hitting walls 11 and 12 as said. As a result, the waves are reflected back into the same direction, from where they came in. Entering with a displacement from the center, they leave with the same displacement at the opposite side of the center line and all trajectories within a corner cube have the same length as if having traveled the distance until the vertex and back. Coming out of the corner, the waves basically take the mean direction of the room diagonal and when arriving at the interface area 10 they are completely unfolded, properly aligned in phase and of ⅛th spherical shape. Therefor the sound is not suffering from distortions and not a single baffle or deflector was necessary. Some space volume hereby is passed repeatedly in different directions with the effect, that the missing space volume has become virtually available by folding the horn within the corner-cube.

The top view is the same as in FIG. 5 shown. The inner corner part, formerly useless for a bass horn, this way became very useful working as an acoustic retro-reflective corner-cube, guiding the waves in and out of the corner, provided there is a proper outlet area size for near plane waves at a suitable position and radiating-direction. The corner cube reflects the waves in a way that their reinitialized trajectories basically are parallel to their initial trajectories. From the position and size of the radiating outlet until the horn mouth 10, only the calculated expansion is possible because of the given boundaries. There is no way for any uncontrolled wave expansion, there is just no space volume for that, on the contrary: super-positioning took place when the waves were mirrored at the corner planes and that cannot unfold faster than the corner is giving space volume for expanding and unfolding, which only completes when the waves are arriving at the interface 10, a ⅛th sphere, now same time vibrating corner cone throat area. From there on, the corner cone guides the waves, limiting their expansion with its law of decreasing flare.

The top view in FIG. 6 depicts a displacement 22 for in-going waves and a conjugate one 23 for out-going waves. The optimal radiating angle and outlet position at distance 19 from the vertex, I found to be best in parallel to the room diagonal and at about ⅔rd the throat 10 radius, this way giving enough room for the expanding wave fronts to hit the ground and wall before the vertex. See also FIG. 9, which is a schematic side view of that illustrative embodiment. From the horn tail 7 within the enclosure 18 in FIG. 6 is only lined the outlet part 20, radiating at best in parallel to the room diagonal 27 towards the nearby plane 12 in such a way, that path 20+21 for radiating into the corner becomes separated from the path 24+25 out of the corner by means of the displacements 22 and 23, thus avoiding that parts of the waves enter back into the horn. The enclosure side wall 28 that faces the room diagonal 17 and extends from the radiating outlet until the interface area 10 at least or more, thereby separates the paths, restricting the out-going path 24 and detaching the space for the in-going wave path 20+21 from it until the interface area 10. After that the horn can expand faster than the corner cone, thus capable of filling the π/2-space completely without provoking a sudden change. The enclosure 18 shall not be located airtight at the wall 12, to avoid a bottleneck in the expansion.

The range of the corner cube behavior depends on the outlet area size and distance 19 from the vertex, which together determine the super-positioning and unfolding-effect afterwards. An acoustic retro-reflective corner cube is working regardless of the angle of incidence. Because bass waves tend to expand, they fill the provided space when coming out of the corner from a small source area and are swinging towards the middle of the room. Substantial deviations in the placing and radiation angle result in performance losses.

To connect the preceding horn with the corner cone throat without a barrier for lowest frequencies, both have to have equal cross sectional areas AND equal flare-rates at the interface, otherwise it won't work without reflections. As an example for calculations, an exponential type horn for 26 Hz is chosen at first. Its area doubles every x=0.73 m and thus flares 10% each 0.1 m:

x=0.1 m*ln(2)/ln(110%)=0.73 m=λ/18. Math. (2)

The circumference of a conventional circular horn mouth in 4πspace is equal to one wave length of 13.2 m, with a radius of 2.1 m and a cross sectional area of 13.9 m², which reduces within π/2-space to 1.73 m² and a radius of 0.74 m. A corner cone has a falling flare and meets said 10% flare at a distance of 2.1 m from the vertex, which equals the radius of the full sphere, but the ⅛th spherical cross sectional area there is 6.9 m², which is 4 times the mouth area of the exponential horn. The calculations simply cannot be changed, the corner cone is given, so the horn has to be longer for two doublings, each of 0.73 m to meet the cone at 10% flare with said cross sectional area of 6.9 m². Observing a max. delay of about 10 ms within the horn, it can't be longer than 350 cm and as such must have an inlet area of 560 cm², which equals a 12″-speaker. Still a big back chamber is required. In all, this is not really an enticing possibility and horns like Pat. DE19537582 are rare: calculated for 13.4 Hz [C7,L23] with an enclosure of 0.77 m³, the reported result is 24 Hz and [FIG. 5] depicts a sudden change in the rate of expansion at the outlet, which is unavoidable when a horn is built within the inner corner space.

While a radiating area of 1.7 m² is sufficient for a corner horn mouth, it doesn't need to be bigger for the cone throat either if the horn flare would be equal alternatively. That interface area is found at half the distance than before, 1.05 m from the vertex. But the cone flare there doesn't match, it is 20%, double the horn's one.

Knowingly, a higher flare than exponential towards a horn mouth produces better spherical shaped wave fronts, therefor such a higher flare not only gives a shorter horn which is no problem for an infinite horn, but results advantageously in better shaped wavefronts and also in less time delay and less space volume.

Hyperbolic exponential horns, often called ‘hypex’, possess a higher curvature and same time show best efficiency. But they are stretched out at the beginning which creates some more distortions and time delay in exchange for a better loading at low frequencies. Both is neither wanted nor needed for a horn which already comes without a cutoff frequency. Also the higher curvature is provided only in the middle part while towards the end exponential flare is approached, so they aren't really useful to solve the problem. A hypex horn for higher low frequency limit—which translates into higher flare at the end—is difficult to calculate with different values of T until the desired low flare at the inlet is achieved.

In practice I found that starting with exponential flare at the inlet of a multi-flare horn with sections of subsequently increasing flare up to five times the flare of the desired low frequency limit until the interface area does not change the characteristics of the complete horn, it continues to work as an infinite horn, but advantageously the horn length, time delay and size of the interface area are reduced significantly. Because the throat area size, found at the place of maximum flare, defines the impedance Math. (1) that becomes transformed to the diaphragm, higher maximum flare results in smaller interface area that provides less radiation resistance and in effect increases the attenuation of lowest frequencies somewhat, while it is of less consequence for higher bass. Trading some attenuation with length, which is related to time delay, may be desirable e.g. in exchange for a higher bass limit, because compensating time delay is not as trivial as attenuation is.

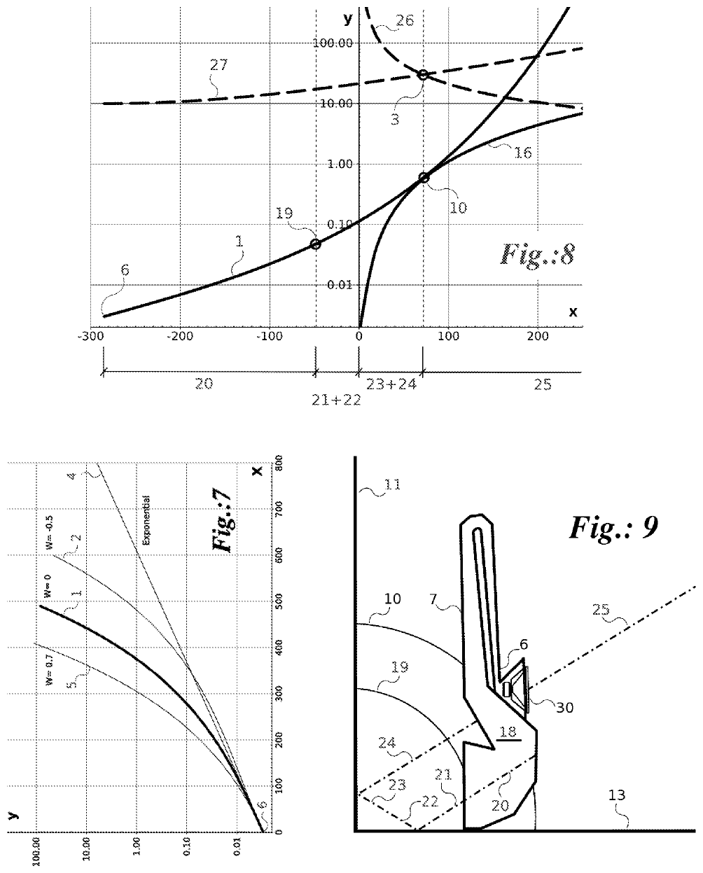

For better illustration in FIGS. 7 and 8, a logarithmic Y-axis shows percent of flare for 10 cm length at dashed lines, while solid lines depict cross sectional areas in m². The linear X-axis is always the length in cm. The example is for 26 Hz frequency limit and 30 cm² of inlet area. Graph 4 is a constant flare exponential expansion, depicting that the desired outcome is not achievable in the above calculated example. The corner cone vertex in FIG. 8 is located at the origin of the X-axis. Negative x-values refer to the in-going and positive values to the out-going wave path graph 1 and 16. Corrective actions may be applied for the detached space of the in-going wave path and the differences of plain and spheric wavefronts.

Positioning the horn graph 1 on the X-axis so as to tangent the corner graph 16 gives the wanted optimal touching point 10 at distance 23+24 from the vertex where both are having substantially equal cross sectional area and same time equal flare at the cross point 3 of graphs 26 and 27. The radius of the ⅛th spherical throat, the interface, then equals that distance 23+24 from the vertex. The distance 21+22 for the radiating outlet from the vertex, I found empirically being best at about ⅔rd of said distance 23+24. An axis-line there crossing the horn graph 1 at position 19 indicates the optimal radiating outlet area of the first horn part. Building that part of length 20 together with the speaker 30 within enclosure 18 completes the horn.

### CONCLUSION

Using the inner corner cube as an acoustic retro-reflective-means solves the problems of missing space volume and enables a smooth coupling of the horn, the corner cone and the listening room without sudden change in the expansion. Without needing any baffle, a 180° folding of the horn inclusive displacement is achieved, together with the extraordinary advantage of being invisible like the corner cone itself which provides very equal sound dispersion and above all ‘infinity’ to the horn, that can result in apparently no limit for lowest audible frequencies. The radiation difference between both sides of the diaphragm makes it possible to omit a closed back chamber, so no volume space of the enclosure is wasted, no air-cushion effects arise and the air-load of the horn still decreases the speakers resonant frequency. The problem of time-delay is resolved with a faster than exponential expansion that allows a shorter than usual horn with an outlet area and an enclosure volume that are only a fraction compared to common horns with similar features even when built within a corner. The resulting economies in material and craftsmanship are about a whole magnitude or more.

The following calculation and graphical solution is provided as an example of the embodiment in FIG. 9, but there are countless possibilities applicable, depending on the choices of speaker and wanted outcome.

I had good results with a 7″-speaker for which the horn inlet 6 was chosen to 30 cm² having some margin in the maximum diaphragm excursion for frequencies even below the initial flare of 26 Hz, which was selected because it is the lowest frequency generated by a concert piano and from there remains less than one octave down to the audible limit.

The horn graph 1 of a multi-flare horn with sections of successively increasing flare or another desired law that matches the cone flare at the interface area. I used a modified exponential-hyperbolic law for the flare rate, shown in FIG. 7:

S_{X}=S_{T}*(exp(sin h(k*x)))² Math. (3)

where
S_{X}=Cross sectional area at distance x from the inlet,
k=2πf₀/c
f₀=Flare frequency at the inlet
c=Velocity of sound

Extending that law by a parameter W with another hyperbolic term makes the expansion adjustable in a wide range that gives a new freedom to vary the horn-length with given inlet and mouth areas: positive values of W increase the curvature 5 in FIG. 7, resulting in still faster rising flare and shorter horns, while negative values of W slow down the flare rise in shape 2, giving longer horns that approach near constant flare of exponential type by the following law:

S_{X}=S_{T}*(exp(sin h(k*x)+W*(cos h(k*x)−1)))² Math. (4)

With parameter W=0, graph 1 reaches the matching area of 1.7 m² at a horn length of 3.82 m. Inserting that in FIG. 8 so as to tangent graph 16 of the derated corner area as said at point 10, an optimized matching interface area for both of 0.6 m² is obtained that shows a maximum flare at cross-point 3 of three times the initial flare and a total horn length of 3.58 m.

This horn section now can be divided into three portions 20, 21+22 and 23+24. The third portion 23+24 of 0.72 m from the vertex to the interface area 10 which same time is the radius of the latter, and the second portion 21+22 from the enclosure outlet to the vertex which was empirically found to be best about 65% to 75% of said radius 23+24, obtaining 0.47 m to 0.57 m, while the greater distance often is better than less.

Remember, that those portions 21 to 24 represent a 180° folding of the horn within the corner cube, whose borders consist of the adjacent planes of the room while the enclosure helps to separate the paths, not perceived by the eyes as parts of a horn, but cannot be changed as you wish without degrading the performance. As a benefit, these folded horn parts vanish from the eyes as the corner cone does, too, while the speaker front is directed to the middle of the room and eventually might radiate higher frequencies directly. So, the really big horn parts are invisible, only the short first portion 20 with the smaller cross sectional areas remains left to be built in a dedicated housing 18.

Opposite to effects by random radiation into corner space, this way the corner became a well defined sound path with boundaries, representing a validated folded horn that avoids waves being reflected back to the diaphragm and is predictable by the disclosed method, despite total simulation is still scientific work in progress at this moment.

At higher bass frequencies, humans can perceive smaller time delays, which limits the useful highest bass frequency of a horn. A higher frequency limit seems to be a worthwhile trade-off for some more attenuation. For said time delay, the corner cone doesn't count, because the cone starts in front of the throat area, 0.72 m from the vertex within the listening room. So the final consideration is about time delay within the horn, that restricts the horn length. The diaphragm here appears to be 2.86 m behind the corner, corresponding to about 8.5 ms time delay which is generally unperceivable below 80 Hz and similar to the time delay of comparable closed box sub-woofers, while ported type sub-woofers show about double the delay.

Supplementary to the top view in FIG. 8, FIG. 9 is a schematic side view in longitudinal section of that embodiment of the horn to show how the first horn portion 7 of the remainder length 20, that is 3.58 m−0.72 m−0.48 m=2.38 m can be housed together with the speaker 30 in an enclosure 18 having a radiating outlet of 0.048 m² found on graph 1 at distance 20 from the inlet 6, at best radiating in parallel to the room diagonal. Exact calculation by said expansion law obtains a net volume of 35 Liter until 0.0485 m² outlet area, a neglectable difference of about 1%, which is less than common tolerances in carpentry craftsmanship. As this outlet area is about a magnitude smaller than the interface area 10, it can be considered a small source of directed plane waves with small dispersion before being reflected the first time as shown in FIG. 5. A transition from any reasonable shape, to triangular shape and ⅛th spherical waves then happens intrinsically by expansion within the corner cube boundaries, the corner planes and the enclosure wall.

The asymmetric radiation into and out of the corner-cube with a displacement has the effect like ‘slicing a piece’ from the inner corner space, which equals a restriction of the outgoing corner-cone to about 60% to 75% at the interface area and can be estimated with help of the enclosure footprint in FIG. 6. After the interface area 10 the horn could expand faster than the cone and together with the same time falling flare of the cone, the small triangular area gap between the plane 12 and the enclosure 18 can therefor be filled up without a sudden change in the expansion.

Alternatively the placing of the enclosure and thus the complete horn may be mirrored and arbitrarily rotated, the enclosure can be placed e.g. horizontally or vertically, hung from the ceiling and used in ¼-, ½- or full space with one speaker for each ⅛th space as is known in the art. Also using two in a right and a left corner or even a pair at ground and ceiling eventually for each corner, known as a double bass array gives still better sound feeling particularly in a bigger room, dance-hall, church or even in open air with artificial corners.

I claim:

1. A loudspeaker comprising
a driver for generating sound waves in the bass range and
a horn having
a channel extending from
an inlet-end to
an ⅛th sphere with origin in a corner, representing a throat area of
an ⅛th space room corner cone, formed by
three adjacent planes of said corner,
where
the driver being mounted with one diaphragm side acoustically sealed to said channel inlet,
the channel having cross sectional areas increasing with distance from the inlet of the channel at a rate of increase increasing with distance from the inlet from a rate of one doubling of the cross sectional area per λ/18th of the lowest desired frequency to at least two but less than 10 times the initial rate of increase,
said channel having at the end substantially the same centerline, same cross sectional area and same rate of expansion as the corner cone at said throat, interfacing both and
being short in relation to λ/4th of the lowest desired frequency.

2. A loudspeaker comprising
the combination of claim 1 in combination with
said horn channel being divided in two portions,
a first portion extending from said inlet to an outlet,
a second portion extending from said outlet to said throat interface,
a retro-reflective corner cube enclosing the space within said ⅛th spherical throat and
three adjacent planes of the corner forming a cooperating 3D-reflective means reflecting waves by 180° with a conjugated displacement relative to the room diagonal,
where
the first portion of the channel being directed towards the vertex with the centerline substantially in parallel to the room diagonal, radiating thereto nearly parallel wavefronts from the outlet located at a distance from the vertex found empirically being best about 0.7 the radius of the corner cone throat,
the second portion being folded by 180°, extending within the corner cube from said outlet virtually until the vertex and from there to the interface area at said throat, the corner walls reflecting and guiding the wave expansion within limits, super-positioning at first and then giving space to unfold the overlaid wave fronts within the corner cube boundaries until the throat interface area.

3. A loudspeaker comprising the combination of claim 2
where
sufficient displacement of the axis of the first channel portion is separating the wave-paths together with the conjugate displacement of the axis of the second portion relative to the room diagonal,
avoiding re-entry of waves into the outlet of the first portion of the channel towards the speaker.

4. An acoustic horn whose cross-sectional area S_{X} increases exponential hyperbolic from a value S_{T} at the throat of the horn substantially in accordance with the law
S_{X}=S_{T}*(exp(sin h(k*x)+W*(cos h(k*x)−1)))²
where
S_{X}=Cross sectional area at distance x from the throat,
k=2πf₀/c
f₀=Low frequency limit of the horn
c=Velocity of sound

5. A method to graphically determine characteristics for connecting a preceding horn to a conical corner horn at same cross sectional areas and same time same rates of flare,
comprising graphical representations for
the cross sectional areas on the y-axis and
distance on the x-axis of a rectangular coordinate system of
the calculated preceding horn with the inlet at the origin, and
the conical horn with the vertex at the origin drawn on transparent media,
where
the origin of the conical horn is initially overlaying
the origin of the preceding horn and from there
shifted along the x-axis until the two graphs tangent,
the touching point depicting
the distance from the vertex for interfacing both, which equals
the radius of the spherical throat area of the conical horn and
the length of the preceding horn channel as
the distance to the origin of the preceding horn curve, both having there
the same cross sectional area and rate of expansion and
the maximum rate of expansion of the whole structure, and
in case of the folded preceding horn of claim 2
the length of the second channel portion was found empirically to be 1.7 times of said throat radius and
the length of the first channel portion as the difference with
the outlet cross sectional area shown at that distance from the channel inlet by the respective graph.
